(19) United States
(12) Patent Application Publication
(10) Pub. No.: US 2002/0070712 A1
(43) Pub. Date: Jun. 13, 2002

(54) Hand-held remote-control device with high-capacitance power supply

(76) Inventor: Senthil G. Arul, West Bloomfield, MI (US)

Correspondence Address: John G. Posa, Esq., GIFFORD, KRASS, GROH, SPRINKLE,, ANDRESON & CITKOWSKI, P.C.,, 280 N. Old Woodward Ave., Suite 400, Birmingham, MI, 48009, US

(21) Appl. No.: 09/736,941

(22) Filed: Dec. 13, 2000

(51) Int. Cl. H04L 17/02; G08C 19/12

(52) U.S. Cl. 320/167; 341/176; 340/825.69

(57) ABSTRACT

Supercapacitor/ultracapacitor technology is applied to hand-held remote-control devices, thereby providing a unit that does not require batteries. In terms of hardware, a device according to the invention includes a hand-held enclosure having a plurality of operator controls supported thereon, a wireless control signal generator, and electronic circuitry interconnecting the operator controls to wireless control signal generator. The circuitry causes the generator to transmit a wireless signal in response to the operator controls so as to affect the operation of the appliance. The device further includes a source of electrical energy to power the circuitry, the source of electrical energy including a supercapacitor or ultracapacitor, and an input to receive externally applied energy to recharge the supercapacitor or ultracapacitor. The input to receive externally applied energy converts mechanical or electrical energy into direct current (DC). Depending upon the embodiment, the energy generator system may be integral to, or separate from, the housing of the unit. A mechanical input includes a miniature generator in electrical communication with the supercapacitor or ultracapacitor for recharging purposes. The input itself may comprise a crank supported on the housing, with a gear train mechanically coupling the crank to the generator, a turnable dial supported on the housing and a spring mechanism coupling the dial to the generator, or a lever arm supported on the housing and a ratchet mechanism coupling the lever arm to the generator.

### FIELD OF THE INVENTION

This invention relates generally to portable electronic devices, including hand-held remote control units, and the like, and, in particular, to such a device having a power storage/supply utilizing a super or ultra-capacitance.

### BACKGROUND OF THE INVENTION

Portable consumer electronic devices continue to be made more compact and with a greater number of features. As such devices become smaller, the demand for smaller, high power-density energy sources also increases. Although the use of lower voltages has helped to reduce energy consumption in some cases, circuits such as amplifier circuits continue to operate most effectively at higher voltage levels.

Existing energy sources such as batteries may be too large, too heavy, or may exhibit insufficient storage capacity for many applications. In addition, the disposal of some battery types presents environmental issues. Since they may be subjected to power surges, batteries must be robust enough to provide a peak current that is substantially higher than the device's average current. As such, batteries are often bigger than they need to be with respect to many low power-consumption applications.

To address these problems, a capacitor may be used in parallel (or in a stand-alone configuration) with a smaller battery to lower the impedance of the energy system. During a current pulse, a properly selected capacitor will reduce the voltage drop in the system because of its lower equivalent series resistance (ESR). To keep size and weight to a minimum, the capacitor may be chosen to have a maximum operating voltage not substantially greater than an operating voltage of the device.

Conventional capacitors can repeatedly provide high levels of power, but generally cannot discharge this power for more than a few microseconds. So-called supercapacitors or ultracapacitors, on the other hand, store high levels of energy in a small volume and are able to release that energy in bursts. A typical ultracapacitor uses two non-reactive porous plates suspended within an electrolyte solution. Energy is stored electrostatically by polarizing the electrolytic solution. A voltage applied to the positive plate attracts the negative ions in the electrolyte, while the potential on the negative plate attracts the positive ions. To increase surface area, a porous carbon-based electrode material is used. Charge separation is also much smaller than can be accomplished using conventional dielectric materials. The combination of enormous surface area and extremely small charge separation gives the ultracapacitor its outstanding capacitance relative to conventional capacitors. There are no chemical reactions involved, and the mechanism is highly reversible, allowing the ultracapacitor to be charged and discharged hundreds of thousands of times. They are also lighter and smaller than batteries with comparable peak-power levels.

It has been recognized that power supplies employing supercapacitors and the like may be beneficial in certain types of portable electronic devices. For example, U.S. Pat. No. 6,097,973 describes an electronic circuit for a portable electronic device that includes an energy source interface, a load coupled to the energy source interface, an energy storage circuit having a maximum operating voltage, and a switch circuit. The switch circuit is coupled to the energy source interface in series with the energy storage circuit. The switch circuit operates to switchably decouple the energy storage circuit in response to a voltage at the load that exceeds the maximum operating voltage.

U.S. Pat. No. 6,061,577 makes reference to a power supply circuit for an external appliance whose consumption varies over time. The circuit comprises an electrochemical cell, a supercapacitor serving as a source of electricity for the appliance, and a chopper voltage converter between the cell and the supercapacitor. The converter serves to charge the supercapacitor at constant current while monitoring the voltage across the terminals thereof. The circuit is applicable to cellular radiotelephones.

### SUMMARY OF THE INVENTION

Broadly, this invention applies super/ultracapacitor technology to hand-held remote-control devices, thereby providing a unit which does not require batteries in the preferred embodiments. Similar to existing devices, the inventive unit preferably provides a universal remote control (URC) in the sense that it transmits appropriate commands to an associated piece of equipment, preferably using infrared signals. The invention is not limited in terms of the type of equipment being controlled, however, and may include televisions, VCRs, DVD players, audio/stereo equipment, vehicle/dwelling/office keyless entry systems, and so forth.

In terms of apparatus, a device according to the invention includes a hand-held enclosure having a plurality of operator controls supported thereon, a wireless control signal generator, and electronic circuitry interconnecting the operator controls to wireless control signal generator. The circuitry causes the generator to transmit a wireless signal in response to the operator controls so as to affect the operation of the appliance. The device further includes a source of electrical energy to power the circuitry, the source of electrical energy including a supercapacitor or ultracapacitor, and an input to receive externally applied energy to recharge the supercapacitor or ultracapacitor.

The input to receive externally applied energy converts mechanical or electrical energy into direct current (DC). Depending upon the embodiment, the energy generator system may be integral to, or separate from, the housing of the unit. In one preferred embodiment, the mechanical input includes a miniature generator in electrical communication with the supercapacitor or ultracapacitor, a crank supported on the housing, and a gear train mechanically coupling the crank to the generator to step-up the number of turn made by a user in proportion to the rotation of the generator.

A second mechanical input embodiment includes a turnable dial supported on the housing and a spring mechanism coupling the dial to the generator. The spring is operative to store mechanical energy supplied by a user through turning of the dial, and release the stored energy to the generator once a desired level of storage is achieved.

A third mechanical input embodiment includes a lever arm supported on the housing and a ratchet mechanism coupling the lever arm to the generator. With this arrangement, a squeezing action of the lever arm against the housing causes the generator to rotate and supply electrical energy to the supercapacitor or ultracapacitor.

In yet a further alternative embodiment, an input is configured to receive externally applied electrical energy. Preferably in this configuration, a set of electrical prongs configured for engagement with an electrical outlet, and a AC-to-DC power supply provides electrical current to recharge the supercapacitor or ultracapacitor.

### BRIEF DESCRIPTION OF THE DRAWINGS

FIG. 1 is a block diagram of a system according to the invention;

FIG. 2 depicts certain electrical subsystems according to the invention, including an energy regulator with a DC/DC converter, a visual indicator, and optional power control switch;

FIG. 3A shows a preferred housing associated with an embodiment of the invention wherein a crank is used to supply mechanical energy to charge a supercapacitor;

FIG. 3B illustrates the inner workings of the energy generator portion of the device of FIG. 3A;

FIG. 3C shows electrical circuitry associated with the energy generator portion of the device of FIG. 3B;

FIG. 4A shows an alternative embodiment of the invention wherein the cranking operation is carried out with a bottom cover coupled to a miniature generator through a coil spring mechanism;

FIG. 4B illustrates the inner workings of the energy generator portion of the device of FIG. 4A in more detail;

FIG. 5A depicts a further alternative embodiment of the invention wherein, by pressing a handle, linear motion is converted a rotary motion through a gear train including a ratchet mechanism;

FIG. 5B illustrates the inner workings of the energy generator portion of the device of FIG. 5A in more detail;

FIG. 6 is a drawing which illustrates yet a further alternative embodiment of the invention wherein an alternator is used to convert AC current into DC current through a male plug point; and

FIG. 7 is a simplified illustration of a high-capacitance remote control unit according to the invention in a docking arrangement with a piece of entertainment-related equipment such as a television set-top box.

### DETAILED DESCRIPTION OF THE INVENTION

Broadly, this invention applies super/ultracapacitor technology to hand-held remote-control devices, thereby providing a unit that does not require batteries for operation. The invention is not limited in terms of the type of equipment being controlled, and may include televisions, VCRs, DVD players, audio/stereo equipment, vehicle/dwelling/office keyless entry systems, and so forth. The hardware associated with the URC may be divided into three systems: (1) the power source; (2) the electrical circuitry operative to generate the infrared command signals; and (3) a housing that provides a convenient way to hold and operate the device. The housing also serves to protect the power source and electrical circuits.

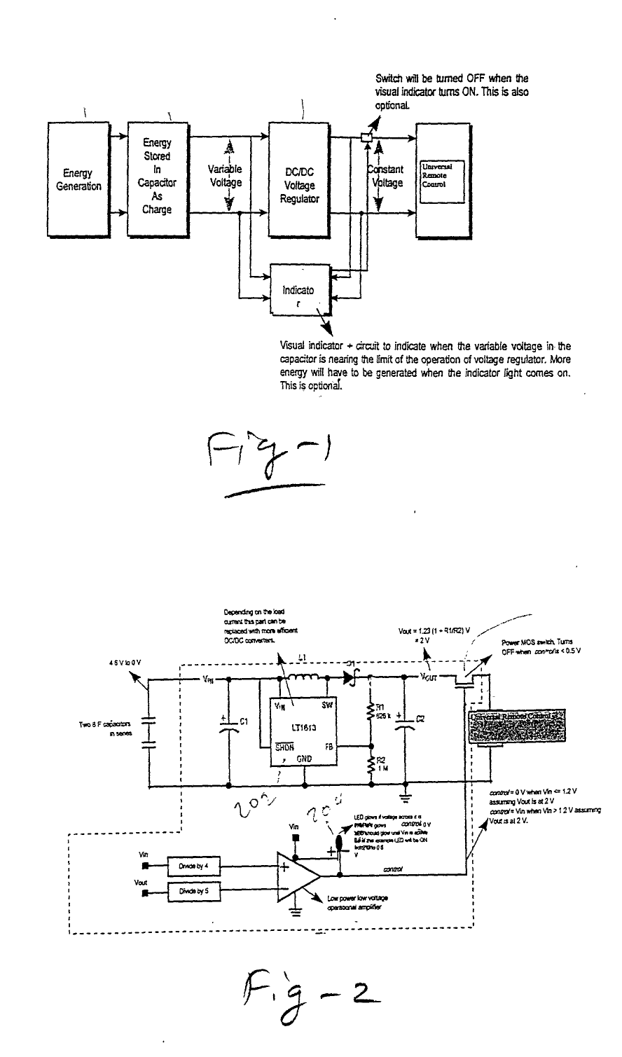

The power source preferably includes an energy generator 102; an energy storage device 104; and an energy regulator 106, as depicted in the block diagram of FIG. 1. The energy generator converts mechanical or electrical energy into electrical energy, preferably direct current (DC). Depending upon the embodiment, the energy generator system may be integral to, or separate from, the housing of the remote control unit. The energy storage device stores the electrical energy within the body of the unit using one or more ultracapacitors. In the preferred embodiment, two ultracapacitors are wired in series to obtain a higher working potential.

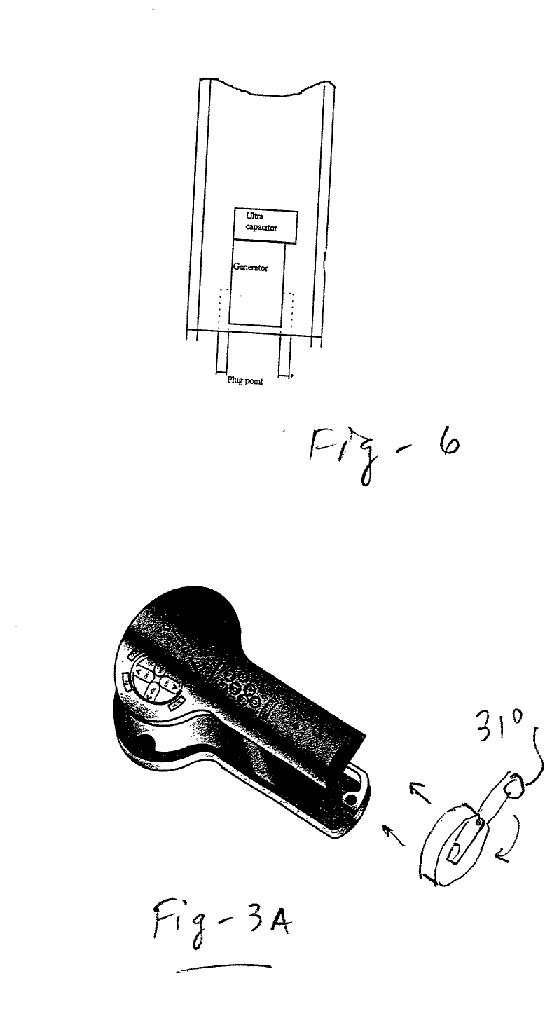

As shown in FIG. 2, the energy regulator 106 preferably includes a DC/DC converter 202, a visual (yes/no) indicator 204, and an optional switch 206. When the circuitry draws current, the regulator system supplies the required power at a constant voltage. The DC/DC converter 202 alters the variable voltage (Vᵢₙₚᵤₜ) from the ultracapacitor(s) to a constant output voltage (Vₒᵤₜₚᵤₜ). The visual indicator 204 shows when the variable voltage (Vᵢₙₚᵤₜ) drops below the constant output voltage (Vₒᵤₜₚᵤₜ), indicating that the capacitor needs to be recharged through the mechanical input or other external power source. The optional switch 206 will disconnect the load from the ultracapacitor when the voltage level falls below a predetermined threshold.

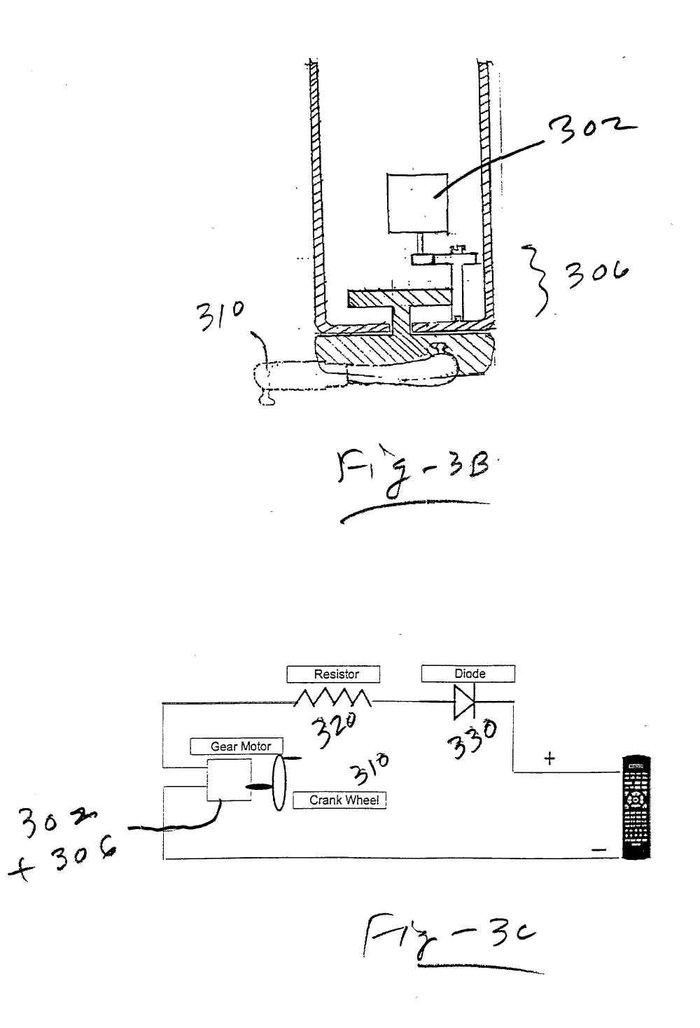

The ultracapacitor may be recharged in various ways according to the invention. A first embodiment is depicted in FIGS. 3A through 3C, wherein a miniature generator 302 is operated by turning a crank 310 which is connected to a step-up gear train 306. FIG. 3A shows the housing overall, FIG. 3B illustrates the inner workings of the energy generator portion, and FIG. 3C shows electrical circuitry.

This system converts mechanical energy into electrical energy using a hand crank, set of gears, a DC Generator, a resistor, and a diode, as shown in FIG. 3C. As the crank is rotated, the generator will produce electric current. The step-up gears help to increase the number of revolutions of the armature in the motor by several order compared to the hand crank. The resistor 320 which dissipates electrical energy is used to control the cranking effort (i.e. higher the resistance, lower the cranking effort). The diode 330 will prevent the flowing of the current back into the generator.

In this embodiment, for every rotation of the crank 310, the dynamo will turn 10 times by virtue of the gear train 306. The crank preferably flips out from a lower-profile stowed position when not in use. Note also that the control panel portion of the device is not unique to this embodiment, in that any of the depicted operator input configurations may be interchanged with any of the various recharging schemes depicted herein.

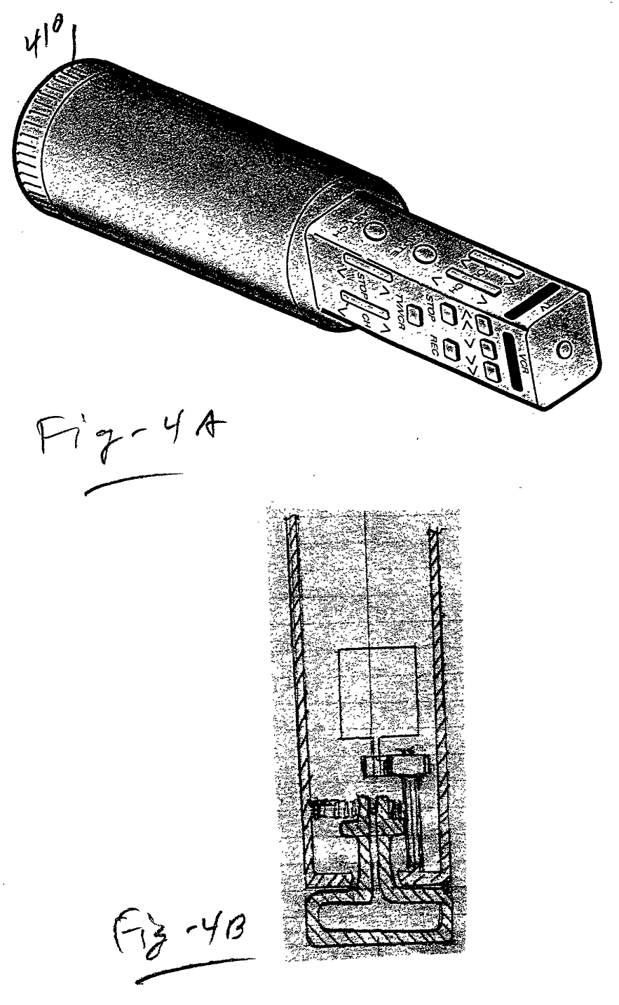

According to a second embodiment, shown in FIGS. 4A and 4B, the cranking operation is carried out with a bottom cover 410 coupled to a miniature generator 412 through a coil spring mechanism 414. FIG. 4A shows the device overall, whereas FIG. 4B depicts the generator aspect in more detail. In this case, the customer turns the bottom cover of the housing few times which, in turn, stores energy in the coil spring. When the spring is taught, it releases the energy to operate the gear train which runs the generator to produce DC current for charging purposes.

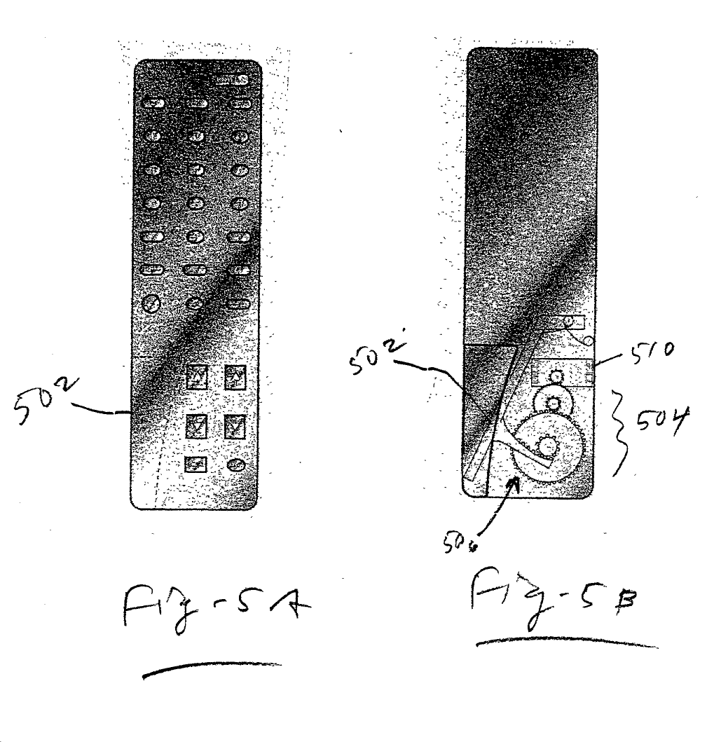

In a third embodiment, by pressing a handle 502, linear motion is converted a rotary motion through a gear train 504 including a ratchet mechanism 506. FIG. 5A shows the housing overall, whereas FIG. 5B more specifically illustrates the generator portion. The gear train 504 operates a generator which supplies DC current for operation of the device, again, without the need for batteries.

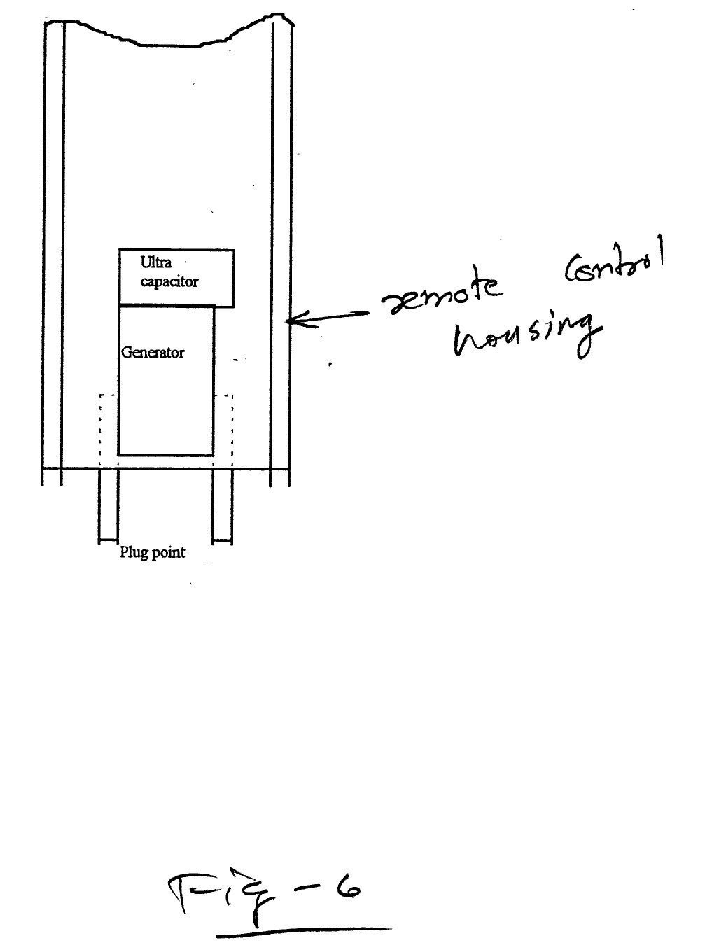

According to a fourth embodiment, electrical circuitry is provided to supply appropriate DC power to recharge the supercapacitor or ultracapacitor without the need for a mechanical input. In the event that AC power is available, an AC-DC converter may be used, preferably in conjunction with a male plug point, as shown in FIG. 6. If DC power of an inconvenient value is available, a DC-DC converter may alternatively be employed. Regardless, when the remote is plugged in to an appropriately equipped receptacle, it should take less than a minute to fully charge the ultracapacitor through the connection.

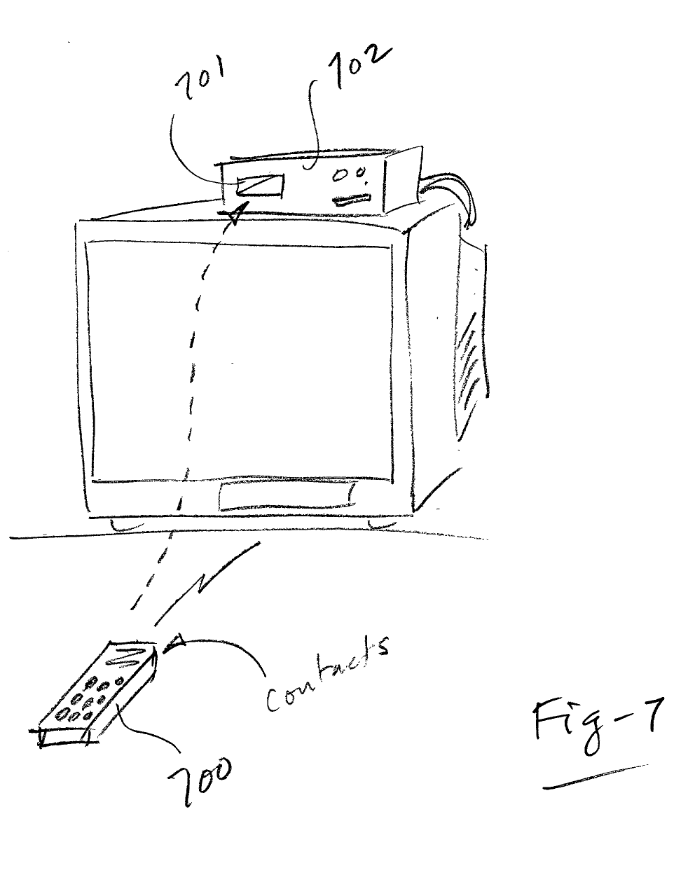

One potentially large market for remote units of the type described herein is hotels and other institutional uses, where batteries may be stolen, or where re-supply or recharging may be labor-intensive or otherwise problematic. Particularly if an all-electrical embodiment is used as described with reference to FIG. 6, a remote control unit according to the invention may be provided in a docking arrangement along with a piece of entertainment-related equipment such as a television set-top box, as shown in FIG. 7. Using such an arrangement, the hotel or other establishment may be assured that the remote units for each room, for example, are always charged, and if the units before depleted, docking for even several seconds should correct the situation. Although a cable-box is at least implied in FIG. 7, the remote according to the invention may also be docked in a suitably equipped TV receiver, VCR/DVD player, audio equipment, personal computer platform, or any other location convenient to electrical and/or mechanical docking:

I claim:

1. A device for wirelessly controlling an appliance, comprising:
a hand-held enclosure having a plurality of operator controls supported thereon;
a wireless control signal generator;
electronic circuitry interconnecting the operator controls to wireless control signal generator, the circuitry causing the generator to transmit a wireless signal in response to the operator controls so as to affect the operation of the appliance;
a source of electrical energy to power the circuitry, the source of electrical energy including a supercapacitor or ultracapacitor; and
an input to receive externally applied energy to recharge the supercapacitor or ultracapacitor.

2. The device of claim 1, wherein the input to receive externally applied energy is a mechanical input.

3. The device of claim 2, wherein the mechanical input includes:
a miniature generator in electrical communication with the supercapacitor or ultracapacitor;
a crank supported on the housing; and
a gear train mechanically coupling the crank to the generator to step-up the number of turn made by a user in proportion to the rotation of the generator.

4. The device of claim 2, wherein the mechanical input includes:
a miniature generator in electrical communication with the supercapacitor or ultracapacitor;
a turnable dial supported on the housing; and
a spring mechanism coupling the dial to the generator, the spring being operative to:
a) store mechanical energy supplied by a user through turning of the dial, and
release the stored energy to the generator once a desired level of storage is achieved.

5. The device of claim 2, wherein the mechanical input includes:
a miniature generator in electrical communication with the supercapacitor or ultracapacitor;
a lever arm supported on the housing; and
a ratchet mechanism coupling the lever arm to the generator, such that a squeezing action of the lever arm against the housing causes the generator to rotate and supply electrical energy to the supercapacitor or ultracapacitor.

6. The device of claim 1, wherein the an input to receive externally applied energy is an electrical input.

7. The device of claim 1, wherein the electrical input includes:
a set of electrical prongs configured for engagement with an electrical outlet; and
an AC-to-DC power supply providing electrical current to recharge the supercapacitor or ultracapacitor.

8. The device of claim 1, wherein the appliance or a unit in electrical communication with the appliance includes a docking station to receive the device.

9. The device of claim 8, wherein the docking station and device include a set of mating electrical contacts enabling the supercapacitor or ultracapacitor to be recharged through the contacts when the device is stowed in the docking station.

10. The device of claim 8, wherein the docking station forms part of a television set-top box.
